(19) United States
(12) Patent Application Publication
(10) Pub. No.: US 2026/0040149 A1
(43) Pub. Date: Feb. 5, 2026

(54) METHODS AND MECHANISMS FOR SLICE COVERAGE ENHANCEMENT

(71) Applicant: NOKIA TECHNOLOGIES OY, ESPOO (FI)

(72) Inventors: Ömer BULAKCI, Munich (DE); Konstantinos SAMDANIS, Munich (DE); Ahmad AWADA, Munich (DE); Muhammad NASEER-UL-ISLAM, Munich (DE); Anatoly ANDRIANOV, Schaumburg, IL (US)

(21) Appl. No.: 19/358,157

(22) Filed: Oct. 14, 2025

Related U.S. Application Data
(62) Division of application No. 18/249,422.
(60) Provisional application No. 63/110,430, filed on Nov. 6, 2020.

(51) Int. Cl. H04W 28/18; H04W 16/10

(52) U.S. Cl. CPC H04W 28/18; H04W 16/10

(57) ABSTRACT

A method and apparatus may include receiving, by a network entity, at least one parameter associated with at least one network slice; generating, by the network entity, at least one domain management data analytics service (MDAS) report based on the received at least one parameter; and transmitting, by the network entity, the at least one MDAS report comprising at least one radio access network recommendation associated with one or more of the at least one network slices.

### CROSS REFERENCE TO RELATED APPLICATION

This application is a Divisional of co-pending application Ser. No. 18/249,422 filed on Apr. 18, 2023, which claims priority to PCT Application No. PCT/EP2021/076362, filed on Sep. 24, 2021, and which claims priority to U.S. Provisional Application No. 63/110,430, filed on Nov. 6, 2020. The entire content of all of the above referenced applications is hereby incorporated by reference.

### TECHNICAL FIELD

Some example embodiments may generally relate to mobile or wireless telecommunication systems, such as Long Term Evolution (LTE), fifth generation (5G) radio access technology (RAT), new radio (NR) access technology, and/or other communications systems. For example, certain example embodiments may relate to systems and/or methods for a management data analytics service related to network slice coverage optimization and load distribution.

### BACKGROUND

Examples of mobile or wireless telecommunication systems may include 5G RAT, the Universal Mobile Telecommunications System (UMTS) Terrestrial Radio Access Network (UTRAN), LTE Evolved UTRAN (E-UTRAN), LTE-Advanced (LTE-A), LTE-A Pro, NR access technology, and/or MulteFire Alliance. 5G wireless systems refer to the next generation (NG) of radio systems and network architecture. A 5G system is typically built on a 5G NR, but a 5G (or NG) network may also be built on E-UTRA radio. It is expected that NR can support service categories such as enhanced mobile broadband (eMBB), ultra-reliable low-latency-communication (URLLC), and massive machine type communication (mMTC). NR is expected to deliver extreme broadband, ultra-robust, low latency connectivity, and massive networking to support the Internet of Things (IoT). The next generation radio access network (NG-RAN) represents the RAN for 5G, which may provide radio access for NR, LTE, and LTE-A. It is noted that the nodes in 5G providing radio access functionality to a user equipment (e.g., similar to the Node B in UTRAN or the Evolved Node B (eNB) in LTE) may be referred to as next-generation Node B (gNB) when built on NR radio, and may be referred to as next-generation eNB (NG-eNB) when built on E-UTRA radio.

### SUMMARY

In accordance with some embodiments, a method may include adjusting, by a network entity, at least one parameter associated with mapping at least one network slice coverage area into a minimum set of access network elements.

In accordance with certain embodiments, an apparatus may include means for adjusting at least one parameter associated with mapping at least one network slice coverage area into a minimum set of access network elements.

In accordance with various embodiments, an apparatus may include at least one processor and at least one memory including computer program code. The at least one memory and the computer program code may be configured to, with the at least one processor, cause the apparatus to at least adjust at least one parameter associated with mapping at least one network slice coverage area into a minimum set of access network elements.

In accordance with some embodiments, a non-transitory computer readable medium may be encoded with instructions that may, when executed in hardware, perform a method. The method may include adjusting at least one parameter associated with mapping at least one network slice coverage area into a minimum set of access network elements.

In accordance with certain embodiments, a computer program product may perform a method. The method may include adjusting at least one parameter associated with mapping at least one network slice coverage area into a minimum set of access network elements.

In accordance with various embodiments, an apparatus may include circuitry configured to adjust at least one parameter associated with mapping at least one network slice coverage area into a minimum set of access network elements.

In accordance with some embodiments, a method may include receiving, by a network entity, at least one parameter associated with at least one network slice. The method may further include generating, by the network entity, at least one domain management data analytics service (MDAS) report based on the received at least one parameter. The method may further include transmitting, by the network entity, the at least one MDAS report comprising at least one radio access network recommendation associated with one or more of the at least one network slices.

In accordance with certain embodiments, an apparatus may include means for receiving at least one parameter associated with at least one network slice. The apparatus may further include means for generating at least one domain management data analytics service (MDAS) report based on the received at least one parameter. The apparatus may further include means for transmitting the at least one MDAS report comprising at least one radio access network recommendation associated with one or more of the at least one network slices.

In accordance with various embodiments, an apparatus may include at least one processor and at least one memory including computer program code. The at least one memory and the computer program code may be configured to, with the at least one processor, cause the apparatus to at least receive at least one parameter associated with at least one network slice. The at least one memory and the computer program code may be further configured to, with the at least one processor, cause the apparatus to at least generate at least one domain management data analytics service (MDAS) report based on the received at least one parameter. The at least one memory and the computer program code may be further configured to, with the at least one processor, cause the apparatus to at least transmit the at least one MDAS report comprising at least one radio access network recommendation associated with one or more of the at least one network slices.

In accordance with some embodiments, a non-transitory computer readable medium may be encoded with instructions that may, when executed in hardware, perform a method. The method may include receiving at least one parameter associated with at least one network slice. The method may further include generating at least one domain management data analytics service (MDAS) report based on the received at least one parameter. The method may further include transmitting the at least one MDAS report comprising at least one radio access network recommendation associated with one or more of the at least one network slices.

In accordance with certain embodiments, a computer program product may perform a method. The method may include receiving at least one parameter associated with at least one network slice. The method may further include generating at least one domain management data analytics service (MDAS) report based on the received at least one parameter. The method may further include transmitting the at least one MDAS report comprising at least one radio access network recommendation associated with one or more of the at least one network slices.

In accordance with various embodiments, an apparatus may include circuitry configured to receive at least one parameter associated with at least one network slice. The circuitry may further be configured to generate at least one domain management data analytics service (MDAS) report based on the received at least one parameter. The circuitry may further be configured to transmit the at least one MDAS report comprising at least one radio access network recommendation associated with one or more of the at least one network slices.

In accordance with some embodiments, a method may include transmitting, by a network entity, at least one parameter associated with at least one network slice. The method may further include receiving, by the network entity, at least one radio access network recommendation associated with one or more of the at least one network slice. The method may further include transmitting, by the network entity, at least one recommended action to at least one user equipment based on the at least one received radio access network recommendation.

In accordance with certain embodiments, an apparatus may include means for transmitting at least one parameter associated with at least one network slice. The apparatus may further include means for receiving at least one radio access network recommendation associated with one or more of the at least one network slice. The apparatus may further include means for transmitting at least one recommended action to at least one user equipment based on the at least one received radio access network recommendation.

In accordance with various embodiments, an apparatus may include at least one processor and at least one memory including computer program code. The at least one memory and the computer program code may be configured to, with the at least one processor, cause the apparatus to at least transmit at least one parameter associated with at least one network slice. The at least one memory and the computer program code may be further configured to, with the at least one processor, cause the apparatus to at least receive at least one radio access network recommendation associated with one or more of the at least one network slice. The at least one memory and the computer program code may be further configured to, with the at least one processor, cause the apparatus to at least transmit at least one recommended action to at least one user equipment based on the at least one received radio access network recommendation.

In accordance with some embodiments, a non-transitory computer readable medium may be encoded with instructions that may, when executed in hardware, perform a method. The method may include transmitting at least one parameter associated with at least one network slice. The method may further include receiving at least one radio access network recommendation associated with one or more of the at least one network slice. The method may further include transmitting at least one recommended action to at least one user equipment based on the at least one received radio access network recommendation.

In accordance with certain embodiments, a computer program product may perform a method. The method may include transmitting at least one parameter associated with at least one network slice. The method may further include receiving at least one radio access network recommendation associated with one or more of the at least one network slice. The method may further include transmitting at least one recommended action to at least one user equipment based on the at least one received radio access network recommendation.

In accordance with various embodiments, an apparatus may include circuitry configured to transmit at least one parameter associated with at least one network slice. The circuitry may further be configured to receive at least one radio access network recommendation associated with one or more of the at least one network slice. The circuitry may further be configured to transmit at least one recommended action to at least one user equipment based on the at least one received radio access network recommendation.

In accordance with some embodiments, a method may include receiving, by a network entity, at least one radio access network recommendation associated with one or more of the at least one network slices. The method may further include performing, by the network entity, at least one configuration optimization associated with at least one base station.

In accordance with certain embodiments, an apparatus may include means for receiving at least one radio access network recommendation associated with one or more of the at least one network slices. The apparatus may further include means for performing at least one configuration optimization associated with at least one base station.

In accordance with various embodiments, an apparatus may include at least one processor and at least one memory including computer program code. The at least one memory and the computer program code may be configured to, with the at least one processor, cause the apparatus to at least receive at least one radio access network recommendation associated with one or more of the at least one network slices. The at least one memory and the computer program code may be further configured to, with the at least one processor, cause the apparatus to at least perform at least one configuration optimization associated with at least one base station.

In accordance with some embodiments, a non-transitory computer readable medium may be encoded with instructions that may, when executed in hardware, perform a method. The method may include receiving at least one radio access network recommendation associated with one or more of the at least one network slices. The method may further include performing at least one configuration optimization associated with at least one base station.

In accordance with certain embodiments, a computer program product may perform a method. The method may include receiving at least one radio access network recommendation associated with one or more of the at least one network slices. The method may further include performing at least one configuration optimization associated with at least one base station.

In accordance with various embodiments, an apparatus may include circuitry configured to receive at least one radio access network recommendation associated with one or more of the at least one network slices. The circuitry may further be configured to perform at least one configuration optimization associated with at least one base station.

### BRIEF DESCRIPTION OF THE DRAWINGS

For proper understanding of example embodiments, reference should be made to the accompanying drawings, wherein:

FIG. 1 illustrates an example of a mismatch between an actual slice deployment and required slice coverage of a network slice.

FIG. 2 illustrates an example of a signaling diagram according to certain embodiments.

FIG. 3 illustrates an example of a flow diagram of a method according to some embodiments.

FIG. 4 illustrates an example of another flow diagram of a method according to various embodiments.

FIG. 5 illustrates an example of another flow diagram of a method according to certain embodiments.

FIG. 6 illustrates an example of another flow diagram of a method according to some embodiments.

FIG. 7 illustrates an example of various network devices according to various embodiments.

FIG. 8 illustrates an example of a 5G network and system architecture according to certain embodiments.

### DETAILED DESCRIPTION

It will be readily understood that the components of certain example embodiments, as generally described and illustrated in the figures herein, may be arranged and designed in a wide variety of different configurations. Thus, the following detailed description of some example embodiments of systems, methods, apparatuses, and computer program products for a management data analytics service is not intended to limit the scope of certain embodiments, but is instead representative of selected example embodiments.

3GPP introduced the technique of network slicing, wherein the underlying physical network infrastructure is divided into several separate, virtual networks. In this way, network slices are logical, self-contained networks sharing a common infrastructure across several end-to-end network domains, including the core network, transport network, and radio access network. In addition, network slicing-related policies and network element (NE) configurations, particularly for RANs, are provided by the network management (NM) system. With this arrangement, network slicing shall fulfill service-level agreements (SLA) throughout a particular geographical area for a particular number of users.

Configuring and operating network slices may provide slice-aware coverage enhancements and adjustments in wireless and mobile communication systems, including 5G. However, simply allocating more cells to a particular slice may be inefficient by wasting network resources. Furthermore, the distribution of users, expected load, and mobility patterns may govern the configuration parameters of each network cell, which can be allocated per slice. Cell configuration parameters may also help in distributing the expected load among neighboring cells.

As the number of network slices increases, automation and data analytics will continue to become increasingly relevant for their efficient operation. To address this, 3GPP specifies some data analytics for core networks, including the network data analytics function (NWDAF) and management data analytics service (MDAS). One of the requirements of an SLA includes slice coverage (i.e., coverage area of a network slice) and expected load within the indicated geographical-area that a slice owner is required to provide within a network slice.

However, slice coverage may not match the actual cellular deployment of the slice owner, and may introduce a trade-off between resources allocated to the slice (e.g., in terms of the number of cells) and the fulfilment of SLA requirements. The slice load experienced by the cell may not be fully available to be served by the selected cell without changes to various configurations, such as load balancing and traffic steering.

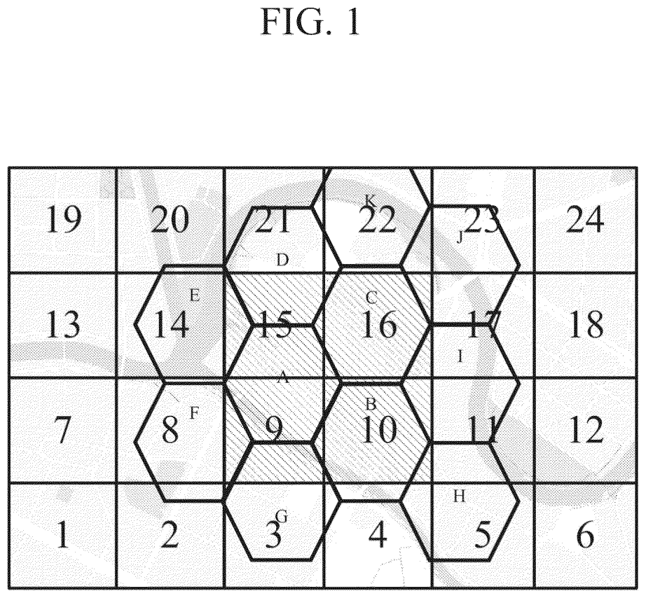

Slice coverage is defined by tracking areas (TA) with associated cells. Other options, e.g., defining slice coverage in terms of cells, are not precluded. However, as mentioned above, the actual geographical coverage of the slice may differ from the existing cell and TA deployment. For example, as illustrated in the example of FIG. 1, the geographical coverage of an exemplary slice X may be defined by tiles 9, 10, 15, and 16. However, the actual geographic area of slice X may differ from that shown in FIG. 1. Cells A through J may be configured by the network operator to support slice X. However, this configuration may not be optimal for a variety of reasons. For example, due to shadowing, UEs in tile 16 may connect to cell K, which may not be configured to support slice X. Thus, UEs served by cell K may fallback to another slice with SLA requirements different from those of slice X, potentially resulting in service degradation. Since fallback to another slice may not be possible, the PDU sessions associated with the non-supported slice would be rejected, causing service interruptions. While slice X could be overprovisioned with a high number of cells surrounding the geographical area, this would significantly increase costs and resource inefficiencies for the network operator.

In addition, cells H and J may only support a very small portion of the geographical area for slice X. Rather than upgrading cells H and J to support slice X, various RAN parameters, including mechanical downtilt, SSB beamforming patterns configured to determine the coverage of a cell, and handover parameters, may be adjusted to these small areas by other neighboring cells supporting slice X, such as B and C.

Cells A-C may also reconfigure their load balancing parameters by associating users with cells, possible through mechanical downtilt, SSB beamforming patterns determining the coverage of a cell, and handover parameters, in order to distribute the expected load in light of user mobility patterns. Thus, operators may utilize limited resources efficiently and service more users. It is noted that FIG. 1 is just one example provided for purposes of illustration of a problem that may be related to certain embodiments described herein. However, it should be understood that other examples are also applicable.

Certain embodiments described herein may have various benefits and/or advantages to overcome the problems and/or issues described above. For example, certain embodiments may analyse actual slice coverage and load distribution needs during deployment, and optimize cell coverage according to network performance, user mobility data, and slice SLA. In particular, some embodiments may configure network resources, and optimize cell configurations so as to address slice requirements in the region, including coverage and load balancing. Furthermore, various embodiments may perform this optimization while managing multiple slices within the same geographical region. Thus, certain embodiments discussed below may be directed at least to improvements in computer-related technology.

Some embodiments discussed herein may include a management data analytics service (MDAS) producer that may provide recommendations for configuring slice coverage optimization and load distribution during the slice instantiation and runtime. This may be based on one or more of slice-aware statistics, e.g., slice-UE distributions and slice-aware mobility events; slice SLAs, e.g., based on GSMA GST attribute area of service; and access node capabilities. The MDAS producer may assist in configuring the RAN to operate within SLA boundaries with minimal resource cost. In addition, based on the output of the MDAS producer, RAN parameters may be adjusted to shape cell edges of particular slices, such as handover parameters, antenna tilts, beam configurations, and TAs. It is noted that slice support may be uniform in a TA, while TA-specific slice support may be coordinated with the core network, e.g., via NGAP procedures, and neighbouring access nodes, e.g., via XₙAP procedures. As a result, SLA requirements for a given slice may be satisfied with as few cells as possible by adjusting cell configurations to satisfy desired coverages and the expected user distribution.

Some embodiments may include mapping the business slice coverage and capacity to the actual RAN deployment during a deployment phase, such as by using geographical areas and/or initial data from existing slices. The existing slices may be of the same slice type, such as by sharing a slice/service type (SST) attribute of a slice identifier (S-NSSAI), and/or may have the same or similar coverage and capacity requirements. As a result, a mapping may be generated including one or more of tracking areas, cell identifiers, and beam identifiers. The mapping may also include 3-dimensional slice owner requirements, such as for drone operators.

With respect to a deployed slice, various statistics on the slice, including performance measurements and key performance indicators (KPIs), may be dynamically collected by the management data analytics function (MDAF) to identify suboptimal resource utilization. The MDAF may also collect user mobility patterns when subscribing to the NWDAF for a particular user group expected to use the requested slice. As an example, the NWDAF may provide aggregate user mobility reflecting gravity points, such as geographical areas frequented by users, in order to improve mobility pattern insights. Furthermore, the MDAF or MDAS producer may provide recommendations to optimize slice coverage and resource utilization. These recommendations may provide guidance for selecting optimal cells and optimizing network configuration parameters. It is noted that slice statistics may be collected before, during, or after slice deployment.

In addition, certain embodiments may be directed towards beam-based dynamic micro optimization. For example, returning to FIG. 1, the configuration of SSB beams determining the coverage of cells B, I, and C may be adjusted to serve the geographic areas served by cells J and H, thereby avoiding the need and cost to reconfigure cells J and H to support slice X. In particular, beam-based dynamic micro optimization may provide guidance on which SSB beams of cells B, I, and C should be adjusted to cover the small, geographic areas of cells J and H with slice support, rather than reconfiguring these cells. Such adjustment guidance could relate to any of beamforming patterns, azimuth and horizontal directions, the number of SSB beams, and the number of SSB beam layers (e.g., 1 or 2 layers with inner beams and outer beams). Adjusting any of these parameters may improve resource utilization efficiency.

The MDAS producer may also consider multiple slices, performance measurements, mobility information, and radio conditions (e.g., minimization of drive test (MDT) inputs) for optimizing coverage parameters of the slice. The network may then determine whether reconfiguring the beams would be sufficient to improve network performance, and if not, reconfigure the cell to support the network slice. The MDAS producer may also include beam measurements, such as which beams have been serving users of a network slice (e.g., slice X and for how long); how many relevant beams from neighboring cells are detected; and short stay with slice unavailability, indicating a short period of time that the UE remains in a cell that does not support the slice. As part of the MDAS producer output, parameters including tilt configuration, handover parameters, and beam selection lists may be modified or short-stayed to adjust slice support.

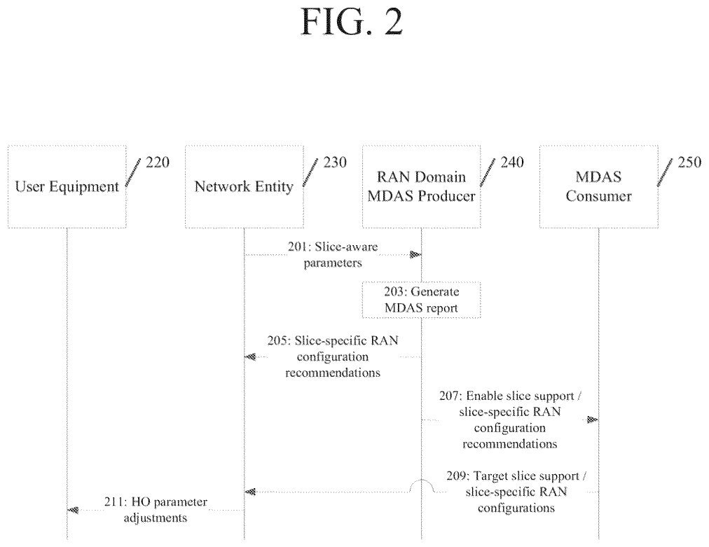

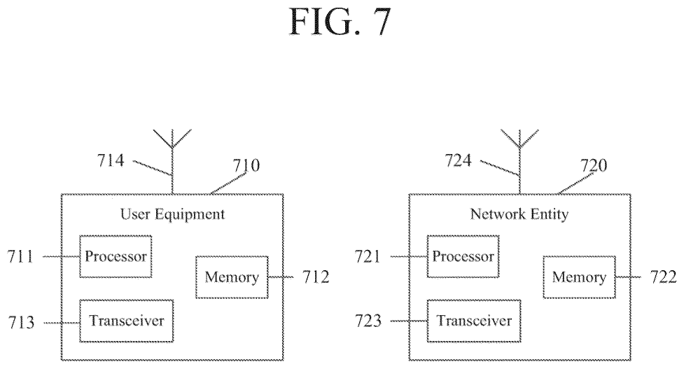

FIG. 2 illustrates an example of a signaling diagram, according to one embodiment. FIG. 2 depicts an example of MDAS producer report enhancing slice coverage and load distribution by rating/factoring slice characteristics according to slice semantics, specific KPIs, and radio conditions. For example, UE 220 may be similar to UE 710, and NE 230, RAN domain MDAS producer 240, and RAN domain consumer 250 may be similar to NE 720, as illustrated in FIG. 7, according to certain embodiments.

In the example of FIG. 2, at 201, NE 230 may transmit RAN domain MDAS parameters associated with specific network slices to RAN domain MDAS producer 240. As an example, the RAN domain MDAS input parameters for analytics may include one or more of parameters in Table 1:

| Data category | Required data |
|---|---|
| Beam Report per Slice | Beam statistics per slice usage in the serving cell: |
| | Beam IDs (SSB IDs or CSI-RS IDs) which have been serving |
| | users of a specific network slice, e.g., slice X |
| | Temporal information of beams serving a specific slice, e.g., |
| | slice X (i.e., when, e.g., morning or evening, and how long) |
| | Number of slice users served by a specific Beam ID |
| | Beam statistics of a neighboring cell measured by specific slice users: |
| | Relevant neighboring Beam IDs (SSB IDs or CSI-RS IDs) |
| | which have been detected by users of a specific network slice, |
| | e.g., Slice X |
| Slice unavailability | Slice unavailability in serving cell: |
| report | Statistics about the rejected or remapped PDU sessions |
| | belonging to a specific slice, e.g., slice X |
| | How long the UEs stayed in a cell not supporting specific |
| | slices, e.g., short stay with slice unavailability |
| | Temporal information of the UEs stayed in a cell not |
| | supporting specific slices, e.g., when these events occurred |
| | Number of UEs stayed in a cell not supporting specific slices |
| | Cell IDs to which the UEs reconnect after staying in a cell not |
| | supporting specific slices, e.g., after short stay with slice unavailability |
| Service Data | S-NSSAI. MDAS producer may derive network topology information. |
| Performance | Radio resource utilization-usage of physical radio resource utilization |
| Measurements | of the network. |
| | Virtual resource usage of NF: The resource usage of virtual network |
| | functions. |
| | Throughput for slice instance: Upstream/downstream throughput from |
| | network and NSI. |
| | RAN UE throughput: KPI shows NG-RAN impacts on service quality |
| | provided to an end-user. |
| Capacity Planning Data | Capacity management |
| MDT Reports | UE measurements related to RSRPs, RSRQs, RLF, RCEF of the cells |
| | in slice and UE location information |
| NWDAF mobility | Group UE mobility analytics |
| analytics | All UE mobility analytics within area of interest defined via slice |
| | coverage |
| Configuration Data | NRM attributes affecting the radio configuration and virtual NF |
| | resource allocation and configuration |
| Network Topology | Topology of the network |

As also illustrated in the example of FIG. 2, at 203, RAN domain MDAS producer 240 may generate MDAS reports. MDAS reports may include recommendation actions on adapting RAN configurations to enhance the slice coverage. For example, MDAS reports may include one or more of the parameters in the Table 2:

| Information | Description |
|---|---|
| gNB incident | Identifier that indicates the gNB configuration |
| identifier | case for slice coverage enhancement |
| | (or slice unavailability) |
| Affected object | Cell Configurations: Antenna Tilt, HO parameters, |
| attributes | cell reselection parameters, beam configuration, |
| | compute resources, etc. |
| Recommended | Recommendation actions to resolve the issue: |
| actions | Antenna Tilt configuration options |
| | HO parameters configuration options |
| | Cell reselection configuration options |
| | Beam configuration options |
| | Compute resource configuration options |
| | Enable slice support in determined cell(s) |
| Root cause | The originator of the issue, e.g., user mobility, load |
| | peak, user distribution, beam configuration, etc. |
| Type of analytics | Statistics or Prediction of security risks |
| Location | Geographical location affected by the gNB incident |
| Start/stop time | Starts/stop time of the incident |
| Severity level | The severity level (e.g., critical, medium, not |
| | important |

In an embodiment, RAN domain MDAS producer 240 may, at 203, transmit the generated MDAS reports to NE 230. Additionally or alternatively, at 207, RAN domain MDAS producer 240 may transmit the generated MDAS reports to RAN domain manager/NSSMF, i.e., MDAS consumer 250. For example, procedure 207 may be performed when the recommendation action in the generated MDAS reports includes a recommendation to configure a slice support for certain gNBs/cells.

At 209, RAN domain manager/NSSMF 250 may transmit to NE 230 configuration modifications associated with the generated MDAS reports and/or configurations associated with gNBs/cells to support new network slices. At 211, NE 230 may transmit to UE 220 handover parameter adjustments based upon the received generated MDAS reports.

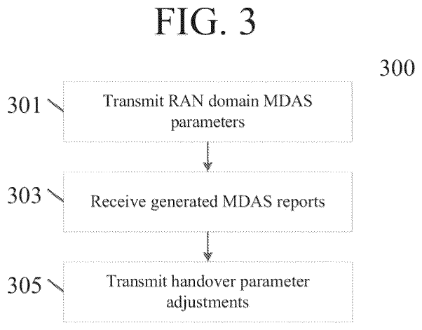

FIG. 3 illustrates an example of a flow diagram of a method 300 that may be performed by a NE, such as NE 720 illustrated in FIG. 7, according to some example embodiments. At 301, the method may include transmitting RAN domain MDAS analytics input parameters, e.g., performance measurements, KPIs, etc., associated with specific network slices to a network node, such as a RAN domain MDAS producer, which may also be similar to NE 720 illustrated in FIG. 7. As an example, the RAN domain MDAS analytics input parameters, e.g., performance measurements, KPIs, etc., may include one or more of the beam report per slice, slice unavailability report, service data, performance measurements, capacity planning data, MDT reports, NWDAF mobility analytics, configuration data, and network topology, as illustrated in Table 1 above.

As also illustrated in the example of FIG. 3, at 303, the method may include receiving generated MDAS reports from the RAN domain MDAS producer, including recommendation actions on adapting RAN configurations to enhance the slice coverage. For example, MDAS reports may include one or more of gNB incident identifier, affected object attributes, recommended actions, root cause, type of analytics, location, start/stop time, and severity level, as illustrated in Table 2 above.

In an embodiment, the method may also include, at 305, transmitting to a UE, such as UE 710 illustrated in FIG. 9, handover parameter adjustments based upon the received generated MDAS reports.

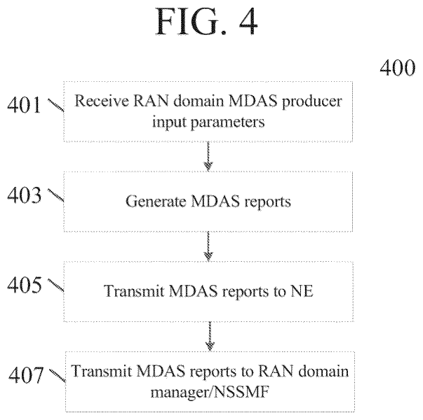

FIG. 4 illustrates an example of a flow diagram of a method 400 that may be performed by a RAN domain MDAS producer, such as NE 720 illustrated in FIG. 7, according to one embodiment. In the example of FIG. 4, the method may include, at 401, receiving RAN domain MDAS analytics input parameters, e.g., performance measurements, KPIs, etc., associated with specific network slices from a network entity, e.g., which may also be similar to NE 720 illustrated in FIG. 7. As an example, the RAN domain MDAS analytics input parameters may include one or more of the beam report per slice, slice unavailability report, service data, performance measurements, capacity planning data, MDT reports, NWDAF mobility analytics, configuration data, and network topology, as illustrated in Table 1 above.

As also illustrated in the example of FIG. 4, at 403, the method may include generating MDAS reports. In an embodiment, MDAS reports may include recommendation actions on adapting RAN configurations to enhance the slice coverage. For example, MDAS reports may include one or more of gNB incident identifier, affected object attributes, recommended actions, root cause, type of analytics, location, start/stop time, and severity level, as illustrated in Table 2 above.

In the example of FIG. 4, at 405, the method may include transmitting the generated MDAS reports to the NE. Additionally or alternatively, at 407, the method may include transmitting the generated MDAS reports to a RAN domain manager/NSSMF, which may also be similar to NE 720 illustrated in FIG. 7. For example, procedure 407 may be performed when the recommendation action in the generated MDAS reports include a recommendation to configure a slice support for certain gNBs/cells.

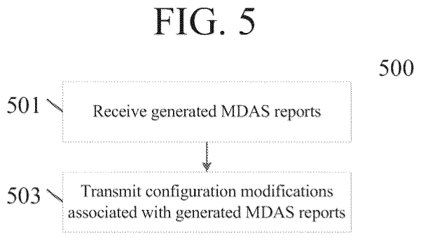

FIG. 5 illustrates an example of a flow diagram of a method 500 that may be performed by a RAN domain manager/NSSMF, such as NE 720 illustrated in FIG. 7, according to an embodiment. In the example of FIG. 5, at 501, the method may include receiving one or more generated MDAS reports from a RAN domain MDAS producer, which may also be similar to NE 720 illustrated in FIG. 7. In an embodiment, the MDAS report(s) may include recommendation actions on adapting RAN configurations to enhance the slice coverage. For example, MDAS reports may include one or more of gNB incident identifier, affected object attributes, recommended actions, root cause, type of analytics, location, start/stop time, and severity level, as illustrated in Table 2 above.

As also illustrated in the example of FIG. 5, at 503, the method may include transmitting to a NE, which may also be similar to NE 720 illustrated in FIG. 7, configuration modifications associated with the generated MDAS reports and/or configurations associated with gNBs/cells to support new network slices.

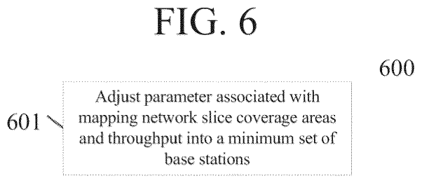

FIG. 6 illustrates an example of a flow diagram of a method 600 that may be performed by a network entity, such as NE 720 illustrated in FIG. 7, according to one embodiment. As illustrated in the example of FIG. 6, at 601, the method may include adjusting parameters associated with mapping network slice coverage areas and load/throughput into a minimum set of base stations.

FIG. 7 illustrates an example of a system according to certain example embodiments. In one example embodiment, a system may include multiple devices or apparatuses, such as, for example, UE 710 and/or NE 720.

UE 710 may include one or more of a mobile device, such as a mobile phone, smart phone, personal digital assistant (PDA), tablet, or portable media player, digital camera, pocket video camera, video game console, navigation unit, such as a global positioning system (GPS) device, desktop or laptop computer, single-location device, such as a sensor or smart meter, or any combination thereof.

NE 720 may be one or more of a base station, such as an eNB or gNB, a serving gateway, a server, and/or any other access node or combination thereof. Furthermore, UE 710 and/or NE 720 may be one or more of a citizens broadband radio service device (CBSD).

NE 720 may further comprise at least one gNB-CU, which may be associated with at least one gNB-DU. The at least one gNB-CU and the at least one gNB-DU may be in communication via at least one F1 interface, at least one Xₙ-C interface, and/or at least one NG interface via a 5GC.

UE 710 and/or NE 720 may include at least one processor, respectively indicated as 711 and 721. Processors 711 and 721 may be embodied by any computational or data processing device, such as a central processing unit (CPU), application specific integrated circuit (ASIC), or comparable device. The processors may be implemented as a single controller, or a plurality of controllers or processors.

At least one memory may be provided in one or more of the devices, as indicated at 712 and 722. The memory may be fixed or removable. The memory may include computer program instructions or computer code contained therein. Memories 712 and 722 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate from the one or more processors. Furthermore, the computer program instructions stored in the memory, and which may be processed by the processors, may be any suitable form of computer program code, for example, a compiled or interpreted computer program written in any suitable programming language.

Processors 711 and 721, memories 712 and 722, and any subset thereof, may be configured to provide means corresponding to the various blocks of FIGS. 2-6. Although not shown, the devices may also include positioning hardware, such as GPS or micro electrical mechanical system (MEMS) hardware, which may be used to determine a location of the device. Other sensors are also permitted, and may be configured to determine location, elevation, velocity, orientation, and so forth, such as barometers, compasses, and the like.

As shown in FIG. 7, transceivers 713 and 723 may be provided, and one or more devices may also include at least one antenna, respectively illustrated as 714 and 724. The device may have many antennas, such as an array of antennas configured for multiple input multiple output (MIMO) communications, or multiple antennas for multiple RATs. Other configurations of these devices, for example, may be provided. Transceivers 713 and 723 may be a transmitter, a receiver, both a transmitter and a receiver, or a unit or device that may be configured both for transmission and reception.

The memory and the computer program instructions may be configured, with the processor for the particular device, to cause a hardware apparatus, such as UE or NE, to perform any of the processes described above (i.e., FIGS. 2-6). Therefore, in certain embodiments, a non-transitory computer-readable medium may be encoded with computer instructions that, when executed in hardware, perform a process such as one of the processes described herein. Alternatively, certain embodiments may be performed entirely in hardware.

In certain embodiments, an apparatus may include circuitry configured to perform any of the processes or functions illustrated in FIGS. 2-6. For example, circuitry may be hardware-only circuit implementations, such as analog and/or digital circuitry. In another example, circuitry may be a combination of hardware circuits and software, such as a combination of analog and/or digital hardware circuitry with software or firmware, and/or any portions of hardware processors with software (including digital signal processors), software, and at least one memory that work together to cause an apparatus to perform various processes or functions. In yet another example, circuitry may be hardware circuitry and or processors, such as a microprocessor or a portion of a microprocessor, that includes software, such as firmware, for operation. Software in circuitry may not be present when it is not needed for the operation of the hardware.

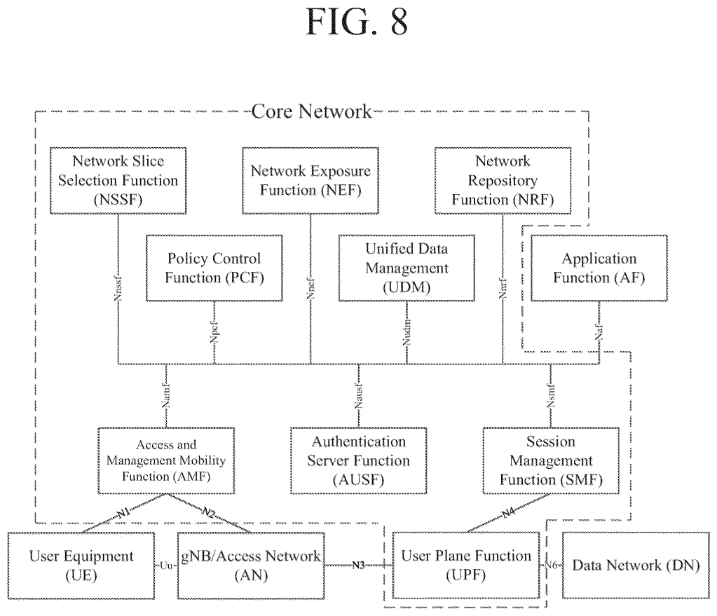

FIG. 8 illustrates an example of a 5G network and system architecture according to certain embodiments. Shown are multiple network functions that may be implemented as software operating as part of a network device or dedicated hardware, as a network device itself or dedicated hardware, or as a virtual function operating as a network device or dedicated hardware. The NE and UE illustrated in FIG. 8 may be similar to UE 710 and NE 720, respectively. The user plane function (UPF) may provide services such as intra-RAT and inter-RAT mobility, routing and forwarding of data packets, inspection of packets, user plane quality of service (QoS) processing, buffering of downlink packets, and/or triggering of downlink data notifications. The application function (AF) may primarily interface with the core network to facilitate application usage of traffic routing and interact with the policy framework.

The features, structures, or characteristics of example embodiments described throughout this specification may be combined in any suitable manner in one or more example embodiments. For example, the usage of the phrases “various embodiments,” “certain embodiments,” “some embodiments,” or other similar language throughout this specification refers to the fact that a particular feature, structure, or characteristic described in connection with an example embodiment may be included in at least one example embodiment. Thus, appearances of the phrases “in various embodiments,” “in certain embodiments,” “in some embodiments,” or other similar language throughout this specification does not necessarily all refer to the same group of example embodiments, and the described features, structures, or characteristics may be combined in any suitable manner in one or more example embodiments.

Additionally, if desired, the different functions or procedures discussed above may be performed in a different order and/or concurrently with each other. Furthermore, if desired, one or more of the described functions or procedures may be optional or may be combined. As such, the description above should be considered as illustrative of the principles and teachings of certain example embodiments, and not in limitation thereof.

One having ordinary skill in the art will readily understand that the example embodiments discussed above may be practiced with procedures in a different order, and/or with hardware elements in configurations which are different than those which are disclosed. Therefore, although some embodiments have been described based upon these example embodiments, it would be apparent to those of skill in the art that certain modifications, variations, and alternative constructions would be apparent, while remaining within the spirit and scope of the example embodiments.

### PARTIAL GLOSSARY

3GPP Third Generation Partnership Project
5G Fifth Generation
5GC Fifth Generation Core
5GS Fifth Generation System
5QI Fifth Generation Quality of Service Indicator
AMF Access and Mobility Management Function
ASIC Application Specific Integrated Circuit
BS Base Station
CBSD Citizens Broadband Radio Service Device
CE Control Elements
CHO Conditional Handover
CN Core Network
CPU Central Processing Unit
CSI-RS Channel Status Information Reference Signal
DC Dual Connectivity
eMBB Enhanced Mobile Broadband
eMTC Enhanced Machine Type Communication
eNB Evolved Node B
eOLLA Enhanced Outer Loop Link Adaptation
EPS Evolved Packet System
gNB Next Generation Node B
GPS Global Positioning System
GSMA Global System for Mobile Communications
GST Generic Slice Template
HDD Hard Disk Drive
HO Handover
ID Identifier
IEEE Institute of Electrical and Electronics Engineers
KPI Key Performance Indicator
LTE Long-Term Evolution
LTE-A Long-Term Evolution Advanced
MAC Medium Access Control
MAC CE Medium Access Control Control Element
MCS Modulation and Coding Scheme
MDA Management Data Analytics
MDAF Management Data Analytics Function
MDAS Management Data Analytics Service
MDT Minimization of Drive Test
MEMS Micro Electrical Mechanical System
MIMO Multiple Input Multiple Output
MME Mobility Management Entity
mMTC Massive Machine Type Communication
MnS Management Services
MPDCCH Machine Type Communication Physical Downlink Control Channel
MTC Machine Type Communication
NAS Non-Access Stratum
NCR Neighbor Cell Relation
NE Network Entity
NF Network Function
NG Next Generation
NGAP Next Generation Application Protocol
NG-eNB Next Generation Evolved Node B
NG-RAN Next Generation Radio Access Network
NM Network Management
NR New Radio
NRM Network Resource Model
NR-U New Radio Unlicensed
NSC Network Slice Customer
NSMF Network Slice Management Function
NSSMF Network Slice Subnet Management Function
NWDAF Network Data Analytics Function
OAM Operation, Administration, & Maintenance
OFDMA Orthogonal Frequency Division Multiple Access
PDA Personal Digital Assistance
PDU Protocol Data Unit
QoS Quality of Service
RA Registration Area
RAM Random Access Memory
RAN Radio Access Network
RAT Radio Access Technology
RCEF Reconnection Establishment Failure
RE Resource Element
RLC Radio Link Control
RLF Radio Link Failure
RRC Radio Resource Control
RSRP Reference Signal Received Power
RSRQ Reference Signal Received Quality
SI Study Item
Service Level Agreement SLA
SMF Session Management Function
S-NSSAI Single Network Slice Selection Assistance Information
SSB Synchronization Signal Block
SST Slice/Service Type
TA Tracking Area
TR Technical Report
TS Technical Specification
TTI Transmission Time Interval
UE User Equipment
UMTS Universal Mobile Telecommunications System
UPF User Plane Function
URLLC Ultra-Reliable and Low-Latency Communication
UTRAN Universal Mobile Telecommunications System Terrestrial Radio Access Network
WLAN Wireless Local Area Network
XₙAP Xₙ Application Protocol

We claim:

1. A method for enabling at least one analytics service, the method comprising:
receiving, by a network entity, at least one parameter associated with at least one network slice;
generating, by the network entity, at least one domain management data analytics service (MDAS) report based on the received at least one parameter; and
transmitting, by the network entity, the at least one MDAS report comprising at least one radio access network recommendation associated with one or more of the at least one network slices.

2. The method of claim 1, further comprising:
adjusting, by the network entity, at least one coverage area during runtime of at least one network slice according to one or more of at least one performance parameter, at least one user mobility pattern, and at least one radio configuration.

3. The method of claim 1, wherein the at least one parameter associated with at least one network slice comprises at least one of:
slice-specific beam usage statistic;
slice unavailability data;
service data;
performance measurement;
capacity planning data;
MDT data;
NWDAF mobility analytics;
configuration data; or
network topology data.

4. The method of claim 1, wherein the at least one slice-specific beam usage statistic comprises at least one of:
at least one beam identifier associated with serving at least one user of at least one specific network slice;
temporal information associated with at least one beam serving at least one specific network slice;
at least one number of slice users served by at least one specific beam identifier; or
at least one neighboring beam identifier detected by at least one user of a specific network slice.

5. The method of claim 1, wherein the at least one beam identifier comprises a synchronization signal block (SSB) identifier or channel status information reference signal (CSI-RS) identifier.

6. The method of claim 1, wherein the slice unavailability data comprises at least one of:
at least one statistic associated with at least one rejected or remapped physical data unit session associated with at least one specific network slice;
at least one time period indicating how long at least one user equipment remained within at least one cell coverage area not supporting at least one specific network slice;
temporal information associated with at least one user equipment remaining in at least one cell coverage area not supporting at least one specific network slice;
at least one number of user equipment remaining in at least one cell coverage area not supporting at least one specific network slice; or
at least one cell identifier associated with at least one user equipment reconnecting after remaining in at least one cell coverage area not supporting at least one specific network slice.

7. The method of claim 1, wherein the at least one MDAS report comprises at least one of:
network entity incident identifier;
affected object attribute;
recommended action;
analytic type;
location;
start and stop time;
root cause; or
severity level.

8. The method of claim 1, wherein the at least one network entity incident identifier comprises at least one of:
at least one identifier indicating at least one network entity configuration case associated with slice coverage enhancement;
at least one identifier indicating at least one network entity configuration case associated with slice throughput enhancement; or
at least one identifier indicating at least one network entity configuration case associated with slice unavailability.

9. The method of claim 1, wherein the at least one affected object attribute comprises at least one of:
antenna tilt;
handover parameter;
cell reselection parameter;
beam configuration; or
compute resource.

10. The method of claim 1, wherein the at least one root cause comprises at least one of:
issue originator;
user mobility;
load peak;
user distribution; or
beam configuration.

11. The method of claim 1, wherein the at least one recommended action comprises at least one of:
antenna tilt configuration option;
handover parameter configuration option;
cell reselection configuration option;
beam configuration option;
compute resource configuration option; or
command configured to enable slice support associated with at least one determined cell.
